(19) United States
(12) Patent Application Publication
(10) Pub. No.: US 2015/0159553 A1
(43) Pub. Date: Jun. 11, 2015

(54) METHODS FOR USE IN TESTING GAS TURBINE FILTERS

(71) Applicant: BHA Altair, LLC, Franklin, TN (US)

(72) Inventors: Brad Aaron Kippel, Greenville, SC (US); Stephen David Hiner, Salisbury (GB); Paul Sherwood Bryant, Amesbury (GB); Giorgio Marchetti, Ancona (IT)

(73) Assignee: BHA Altair, LLC, Franklin, TN (US)

(21) Appl. No.: 14/097,884

(22) Filed: Dec. 5, 2013

(51) Int. Cl. F02C 7/04; B01D 46/42; G01N 25/72

(52) U.S. Cl. CPC F02C 7/04; G01N 25/72; B01D 46/4263

(57) ABSTRACT

Methods of testing gas turbine filter elements under high or low temperature operating environments are provided. In one aspect, the method includes performing a fractional efficiency test on a filter. The method also includes heating or cooling the filter to a temperature that is higher or lower than an ambient temperature. The method further includes performing a second fractional efficiency test on the filter after the filter has been heated or cooled for a period of time at the temperature.

### BACKGROUND

The subject matter disclosed herein relates generally to gas turbines, and more particularly, to methods for use in testing gas turbine filter elements.

Gas turbines are widely used for disparate purposes and in different operating environments. Some turbines may be exposed to harsh operating conditions and/or may be subjected to high or low temperatures. To reduce the effects of such adverse operating conditions, at least some known turbines include a filter assembly that filters air entering the turbine assembly. However, over time, continued operation in high or low temperatures may cause elements in the filter assembly to fail prematurely during operation. Compromised filter elements may expose the gas turbine to an increased amount of harmful foreign objects.

To reduce the likelihood of a filter becoming compromised, at least some known filter assemblies are subjected to periodic and/or scheduled testing. For example, conducting accelerated life tests on gas turbine filter elements may properly vet a type of filter for use in high or low temperatures and thus reduce the risk of failure during operation. However, currently no industry standard exists for testing the durability of gas turbine filter elements in high temperature or low temperature operating environments. As such, to prevent damage to turbine assemblies used with such filter elements, known filter assemblies may be replaced periodically. However, replacing filter elements only periodically may allow turbines to operate for prolonged periods with compromised filter elements.

### BRIEF DESCRIPTION

In one aspect, a method of testing a gas turbine filter for use in a high ambient temperature operating environment is provided. The method includes performing a first fractional efficiency test on the filter. The method also includes heating the filter to a first temperature that is higher than the ambient temperature surrounding the filter. In addition, the method includes performing a second fractional efficiency test on the filter after the filter has been heated for a predetermined amount of time at the first temperature.

In another aspect, a method of testing a gas turbine filter for use in a low ambient temperature operating environment is provided. The method includes performing a first fractional efficiency test on the filter. The method also includes cooling the filter to a first temperature that is lower than the ambient temperature surrounding the filter. Further, the method includes performing a second fractional efficiency test on the filter after the filter has been cooled for a predetermined amount of time at the first temperature.

### BRIEF DESCRIPTION OF THE DRAWINGS

FIG. 1 is a schematic illustration of an exemplary gas turbine engine system including an exemplary inlet filter house;

FIGS. 2A and 2B are a flow chart of an exemplary method of testing gas turbine filter elements used in high temperature operating environments;

FIGS. 3A and 3B are a flow chart of an exemplary method of testing gas turbine filter elements used in low temperature operating environments;

FIG. 4 is a schematic illustration of an exemplary filter test set-up.

### DETAILED DESCRIPTION OF THE INVENTION

The exemplary methods described herein overcome the lack of a known industry standard for testing the durability of gas turbine filter elements used in high or low temperature operating environments. More specifically, the embodiments described herein enable accelerated life tests to be performed for turbine filter elements used in high temperature or low temperature operating environments.

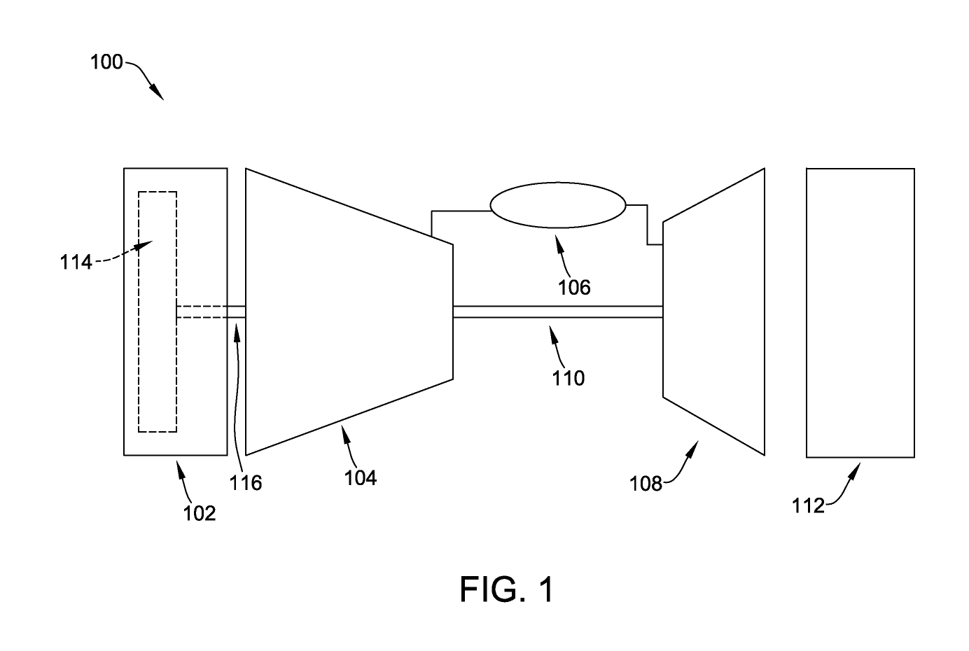

FIG. 1 is a schematic diagram of an exemplary gas turbine engine system 100. In the exemplary embodiment, gas turbine engine system 100 includes, coupled in serial flow arrangement, an inlet filter house 102 that includes a plurality of filter elements 114, a compressor 104, a combustor assembly 106, and a turbine 108 that is rotatably coupled to compressor 104 via a rotor shaft 110.

Gas turbine 100 may be used with a variety of filter types of varying efficiencies, including medium efficiency filters, high efficiency filters, and/or very high efficiency filters. Embodiments of the present invention are intended for use with all types of applicable filters compatible with a gas turbine. Filter efficiency is one of the defining characteristics of filter media, and efficiency may be determined by dividing the number of particles trapped in a filter by the total number of particles found in the air upstream from the filter. The probability that a particle may flow through a filter media is primarily a function of the particle's size as compared to the relative size of pores in the filter media. Therefore, for each filter type, there is a penetration curve of particle size versus percent penetration. Fractional efficiency tests are used to determine the shape of the penetration curve. For example, fractional efficiency tests include, but are not limited to, American Society of Heating, Refrigerating and Air-Conditioning Engineers (ASHRAE) 52.2. European Norm (EN) 779, and EN1822.

During operation, in the exemplary embodiment, ambient air flows into inlet filter house 102, wherein the ambient air is filtered. In the exemplary embodiment, the filtered air is channeled through an air inlet 116 towards compressor 104, wherein the filtered air is compressed prior to it being discharged towards combustor assembly 106. In the exemplary embodiment, the compressed air is mixed with fuel, and the resulting fuel-air mixture is ignited within combustor assembly 106 to generate combustion gases that flow towards turbine 108. In the exemplary embodiment, turbine 108 extracts rotational energy from the combustion gases and rotates rotor shaft 110 to drive compressor 104. Moreover, in the exemplary embodiment, the gas turbine engine system 100 drives a load 112, such as, for example, a generator, coupled to rotor shaft 110.

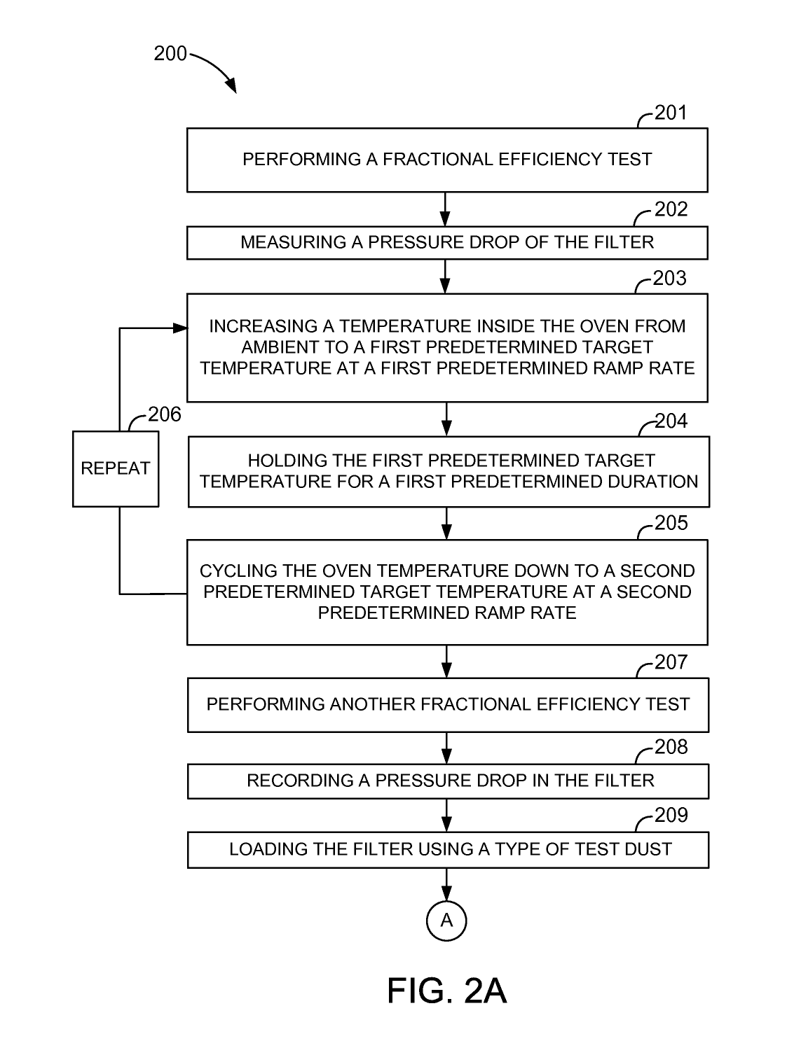

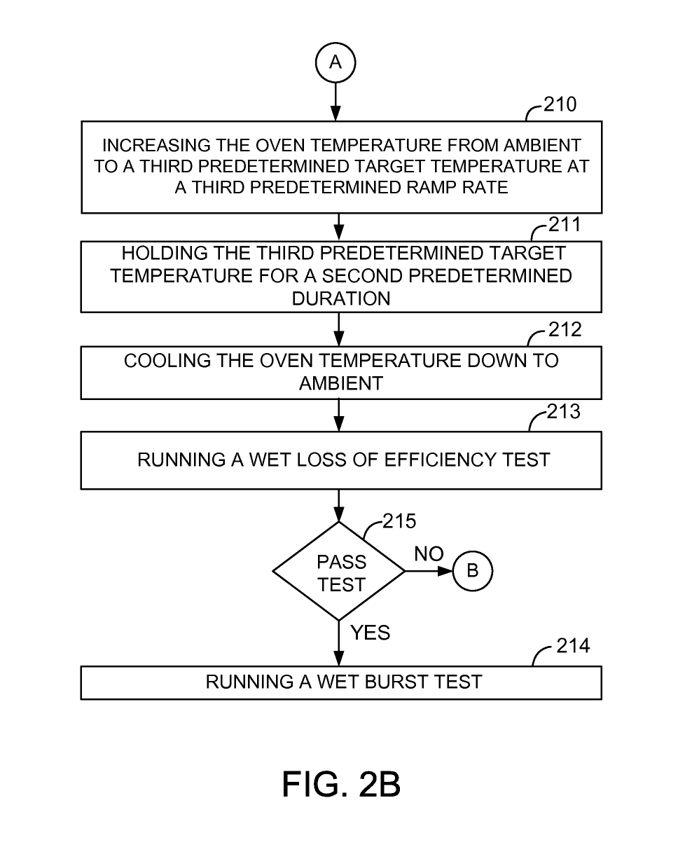

FIG. 2 is a flow chart of an exemplary method 200 that may be implemented to conduct an accelerated life test for gas turbine filter elements, such as, for example, filter elements 114 (shown in FIG. 1), used in high ambient temperature operating environments. Method 200 is generally presented chronologically. But in alternative embodiments, method 200 may be implemented in a different sequential order. In the exemplary embodiment, method 200 is described as being used to conduct accelerated life tests on an individual filter. Alternatively, method 200 may be used to conduct accelerated life tests on multiple filters simultaneously. As used herein, operating environments having ambient temperatures about or exceeding 50° C. (122° F.) are considered high temperature operating environments. Alternative embodiments of the present invention apply to operating environments with temperatures less than 50° C.

In the exemplary embodiment, an initial fractional efficiency test is conducted 201 at operating airflow to evaluate the performance of the test filter as a function of particle size. In one embodiment, the fractional efficiency test is performed 201 based on procedures set forth in ASHRAE 52.2. The drop in pressure across the filter is measured 202 during the fractional efficiency test using a pressure transmitter or pressure gauge. The filter is then inserted in an oven and heated 203 from ambient to a predetermined temperature at a controlled ramp rate. As used herein, the oven should be capable of controlling the speed of temperature change and maintaining the temperature within a desired tolerance span. Also as used herein, the ambient temperature is the room temperature inside the testing facility. For example, in one embodiment, the oven temperature is increased from ambient to a predetermined high of about 75° C. (167° F.) and at a constant ramp rate of about 1° C. (33.8° F.) per minute. Alternatively, the predetermined temperature may be higher or less than 75° C., such as, for example, in a range of about 50° C. (122° F.) to about 100° C. (212° F.). Moreover, the ramp rate may be faster or slower than 1° C. per minute, such as, for example, in a range of about 0.1° C. (32.2° F.) to about 15° C. (59° F.) per minute.

Once the desired temperature inside the oven is attained, the temperature is maintained 204 for a predetermined duration. For example, in one embodiment, the oven temperature is maintained for a duration of about eight hours. Alternatively, the temperature may be maintained for a duration longer or shorter than eight hours, such as, for example, in a range of about one to about twenty-four hours. The oven temperature is then cycled 205 to a predetermined low and at a controlled ramp rate. For example, in one embodiment, the oven is cycled 205 to about −31.7° C. (−25.1° F.) and at a ramp rate of about 1° C. (33.8° F.) per minute. Alternatively, the oven temperature may be cycled to a temperature that is warmer or colder than about −31.7° C., such as, for example, to a range between about 0° C. (32° F.) to about −50° C. (−58° F.). Alternatively, the ramp rate may also be faster or slower than about 1° C. per minute, such as, for example, in a range of about 0.1° C. to about 15° C. per minute. Processes 203-205 may be repeated 206 as many times as necessary to introduce thermal cycling stress on the filter being tested. In one embodiment, processes 203-205 are repeated three times.

The filter is then removed from the oven and an additional fractional efficiency test is performed 207 at operating airflow on the filter to enable changes in the profile of the penetration curve to be detected. The drop in pressure across the filter during the fractional efficiency test is then measured 208.

The filter is then loaded 209 with a type of fine test dust in a wind tunnel. For example, in one embodiment, the filter is loaded 209 up to about 8 inches (20.32 cm) water column differential pressure using SAE fine test dust. Alternatively, the filter may be loaded between 1 inch (2.54 cm) and 25 inches of water column differential pressure of a type of test dust. As used herein, different types of test dusts vary in size and structure and are selected to simulate atmospheric particulates that may come in contact with the filter in its intended operational environment. The dust introduces a pressure load stressing the filter being tested. Examples of test dust types may include, but are not limited to: SAE Fine Dust, ASHRAE 52.2, Carbon Black, ISO, ARAMCO, and the like. Method 200 is intended for use with all test dust types depending on the operating conditions of the associated gas turbines.

The filter is then inserted in an oven and is heated 210 from ambient to a predetermined temperature at a controlled ramp rate. For example, in one embodiment, the oven temperature is heated from ambient to about 75° C. at a ramp rate of 1° C. per minute. Alternatively, the predetermined temperature may be warmer or colder than 75° C., such as, for example, in a range of about 50° C. to about 100° C. Alternatively, the ramp rate may be faster or slower than 1° C. per minute, such as, for example, in a range of about 0.1° C. to about 15° C. per minute. The predetermined oven temperature is then maintained 211 for a predetermined duration. For example, in one embodiment, the temperature is maintained 211 for about four hours. Alternatively, the predetermined duration may be maintained for a greater or less amount of time, such as, for example, in a range of about one to twenty-four hours. The oven temperature is then cooled 212 to ambient temperature. After removing the filter from the oven, a wet loss of efficiency test is performed 213 at design operating airflow.

In a wet loss of efficiency test, the filter testing system includes a full sized module of at least one filter element set operating at design operating airflow, a dust feeding system, and water spray nozzles. The dust feeding system includes a dust feeder and one or more compressed air operated dust injectors. The dust feeder feeds dust at a uniform continuous rate and the dust injectors disperse the dust uniformly across the air inlet face of the module. The water spray nozzles disperse water uniformly across the air inlet face of the module. The airflow is constant throughout the duration of the test. Filter elements, such as filter elements 114 (shown in FIG. 1), should withstand a desired differential pressure. For example, in one embodiment, the filter elements 114 should withstand a differential pressure of about 15.0 inches water column of pressure drop (3736 Pa) at design operating airflow without damage or noticeable loss of filtration efficiency. Generally speaking, a filter passes the wet loss of efficiency test if fractional efficiency does not drop more than a desired percentage of the efficiency at a particular Geometric Mean Particle Size.

The weight of the test dust consumed in the wet loss of efficiency test is measured 213. Alternatively, leaks may be visually identified. If the filter passed 215 the wet loss of efficiency test, then a wet burst test at design operating airflow is performed 214. If the filter failed 215 the wet loss of efficiency test, then the test ends and the filter is determined to be not suitable for use in high temperature operating environments.

In a wet burst test, the filter testing system includes a full sized module of at least one filter element set operating at design operating airflow, a dust feeding system, and water spray nozzles. The dust feeding system includes a dust feeder and one or more compressed air operated dust injectors. The dust feeder feeds dust at a uniform continuous rate and the dust injectors disperse the dust uniformly across the air inlet face of the module. The water spray nozzles disperse water uniformly across the air inlet face of the module. The airflow is constant throughout the duration of the test. The filter elements 114 should withstand a differential pressure at a desired airflow without bursting. For example, in one embodiment, the filter elements 114 should withstand a differential pressure of about 25 inches water column of pressure drop (6227 Pa) at design operating airflow without bursting.

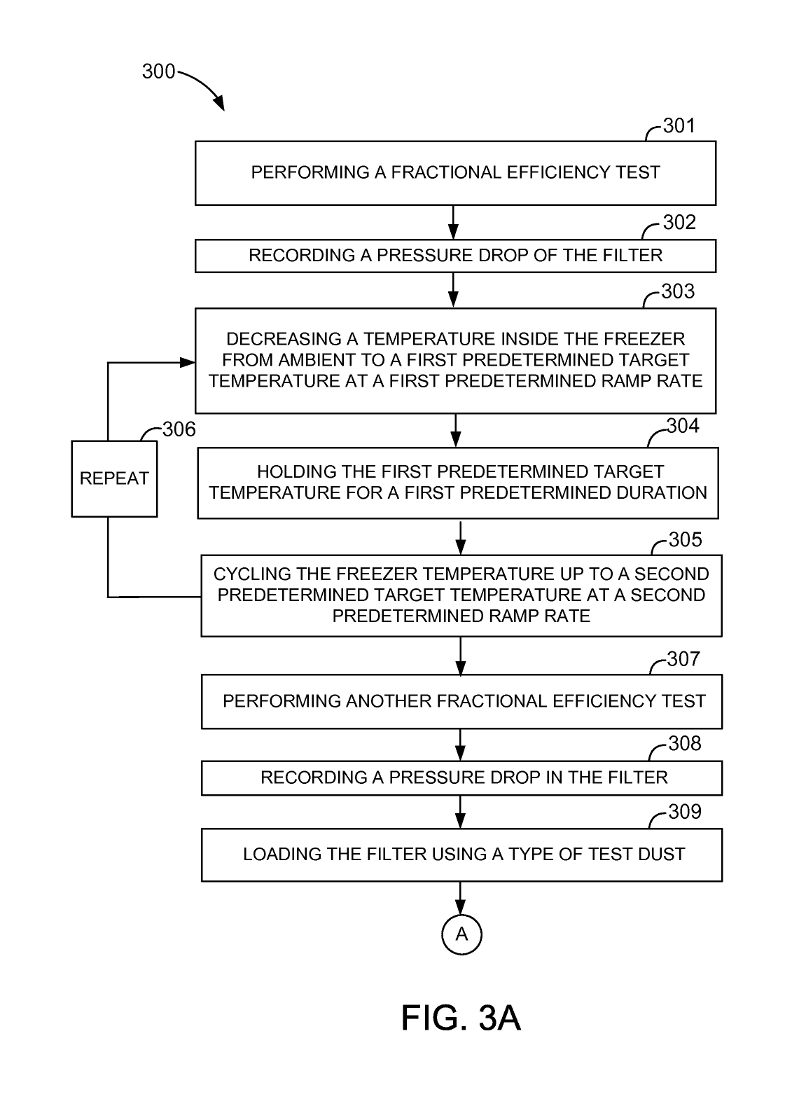

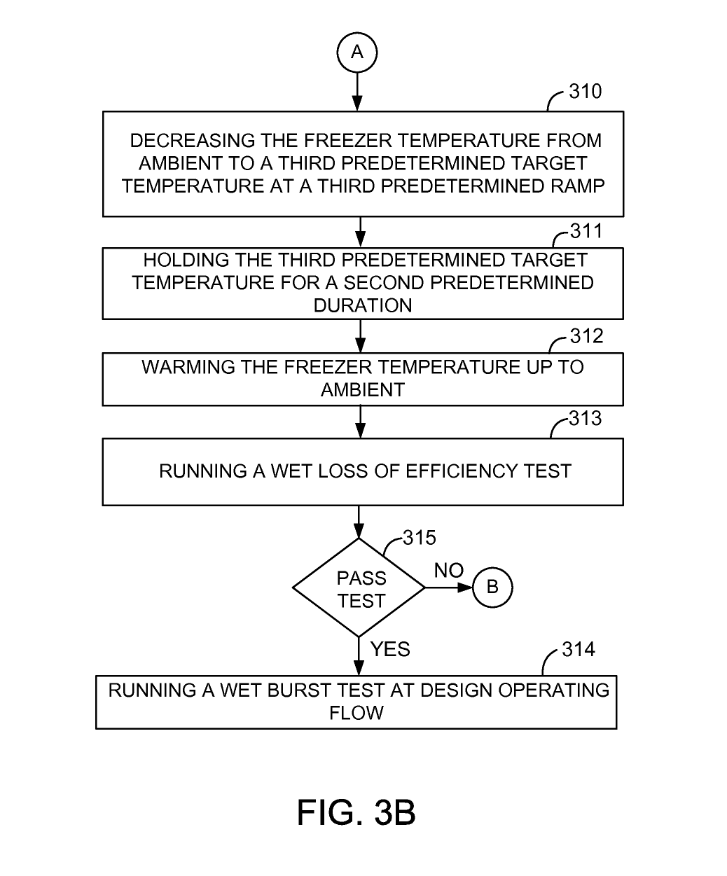

FIG. 3 is a flow chart of an exemplary method 300 that may be implemented to conduct an accelerated life test for gas turbine filter elements, such as, for example, filter elements 114 (shown in FIG. 1), used in low ambient temperature operating environments. Method 300 is generally presented chronologically. But in alternative embodiments, method 300 may be implemented in a different sequential order. In the exemplary embodiment, method 300 is described as being used to conduct accelerated life tests on an individual filter. Alternatively, method 300 may be used to conduct accelerated life tests on multiple filters simultaneously. As used herein, operating environments having ambient temperatures about or less than −31.7° C. (or −25° F.) are considered low temperature operating environments. Alternative embodiments of the present invention apply to operating environments with temperatures lower than −31.7° C., such as, for example, within a range of about −30° C. to about −100° C.

In the exemplary embodiment, an initial fractional efficiency test is conducted 301 to evaluate the performance of the test filter as a function of particle size. In one embodiment, the fractional efficiency test is performed 301 at operating airflow based on procedures set forth in ASHRAE 52.2. The drop in pressure across the filter during the fractional efficiency test is then measured 302 using a pressure transmitter or pressure gauge. The filter is then inserted in a freezer and cooled 303 from ambient to a predetermined low temperature at a controlled ramp rate. As used herein, the freezer is capable of controlling the speed of temperature change and maintaining constant temperature within a desired tolerance span. For example, in one embodiment, the temperature inside the freezer is decreased from ambient to a predetermined low of about −51.1° C. (or −60° F.) at a ramp rate of about 1° C. per minute. Alternatively, the predetermined temperature may be higher or lower than −51.1° C., such as, for example, in a range of about −30° C. to about −100° C. Moreover, the ramp rate may also be greater or less than 1° C. per minute, such as, for example, in a range from about 0.1° C. to about 15° C. per minute.

Once the desired temperature inside the freezer is attained, the temperature is maintained 304 for a predetermined duration. For example, in one embodiment, the predetermined temperature inside the freezer may be maintained for a duration of about eight hours. Alternatively, the temperature may be maintained for a duration of a longer or shorter amount of time, such as, for example, within a range of about one to about twenty-four hours. If the filter is self-cleaning, then activate the cleaning system to perform a cleaning cycle on the filter a desired number of times before proceeding. For example, in one embodiment, a self-cleaning filter is pulsed for about 10 times. Alternatively, the filter may be pulsed for more or less than about 10 times such as, for example, in a range between 1 to 100 times. This pulsing is designed to introduce a shock force to the filter in order to determine if the filter elements will suffer brittle fracture, which is a common failure mechanism at cold ambient temperatures. A thermocouple may be installed to ensure that the minimum temperature is maintained during pulsing. Self-cleaning filters are usually used in areas with high dust loads or subject to frosty conditions. Self-cleaning filters are designed to receive short bursts of reverse air flow capable of removing particulates or ice buildup from the filter surface. The freezer temperature is then cycled 305 to a predetermined temperature and at a controlled ramp rate. For example, in one embodiment, the freezer is cycled 305 to about 50° C. and at a ramp rate of about 1° C. per minute. Alternatively, the freezer may be cycled 305 to a temperature that is warmer or colder than about 50° C., such as, for example, to a range between about 40° C. to about 100° C. Alternatively, the ramp rate may also be greater than or less than 1° C. per minute, such as, for example, within a range of about 0.1° C. to about 15° C. per minute. Processes 303-305 may be repeated 306 as many times as necessary to introduce thermal cycling stress on the filter being tested. In one embodiment processes 303-305 are repeated three times.

The filter is then removed from the freezer and an additional fractional efficiency test is performed 307 at operating airflow on the filter to enable changes in the filter's penetration curve to be detected. The drop in pressure across the filter during the fractional efficiency test is then measured 308.

The filter is then loaded with a type of fine test dust in a wind tunnel. For example, in one embodiment, the filter is loaded 309 up to 8 inches (20.32 cm) water column differential pressure using SAE fine test dust. Alternatively, the filter may be loaded between 1 inch and 25 inches of water column differential pressure of a type of test dust. The dust introduces a pressure load stressing the filter being tested. Alternatively, another type of test dust may be used. Method 300 is intended for use with all test dust types depending on the operating conditions of the associated gas turbines.

The filter is then inserted in a freezer and is cooled 310 from ambient to a predetermined temperature and at a controlled ramp rate. For example, in one embodiment, the freezer temperature is cooled from ambient to −51.1° C. (−60° F.) and at a ramp rate of 1° C. per minute. Alternatively, the predetermined temperature may be higher or less than −51.1° C., such as, for example, in a range of about −30° C. to about −100° C. Alternatively, the ramp rate may be higher or less than 1° C. per minute, such as, for example, within a range from about 0.1° C. to about 15° C. per minute. The predetermined temperature is then maintained 311 for a predetermined duration. For example, in one embodiment, the temperature is maintained 311 for about four hours. Alternatively, the predetermined duration may be maintained for longer or shorter than about four hours, such as, for example, in a range of about one to about twenty-four hours. The freezer temperature is then warmed 312 to ambient temperature. After removing the filter from the freezer, a wet loss of efficiency test substantially similar to the one described hereinabove with respect to step 213 is performed 313 at design operating airflow. Filter elements, such as filter elements 114 (shown in FIG. 1), should withstand a desired differential pressure. For example, in one embodiment, the filter elements 114 should withstand a differential pressure of about 15.0 inches water column of pressure drop (3736 Pa) at design operating airflow without damage or noticeable loss of filtration efficiency. Generally speaking, a filter passes the wet loss of efficiency test if fractional efficiency does not drop more than a desired percentage of the efficiency at a particular Geometric Mean Particle Size. The weight of the test dust consumed in the wet loss of efficiency test is measured; or as an alternative, leaks are visually identified. If the filter passed 315 the wet loss of efficiency test, then a wet burst test substantially similar to the one described hereinabove with respect to step 214 is performed 314 at design operating airflow. If the filter failed 315 the wet loss of efficiency test, then the test ends and the filter is determined to be not suitable for use in low temperature operating environments. The filter elements 114 should withstand a differential pressure at a desired airflow without bursting. For example, in one embodiment, the filter element should withstand a differential pressure of about 25 inches water column of pressure drop (6227 Pa) at design operating airflow without bursting, in the wet condition.

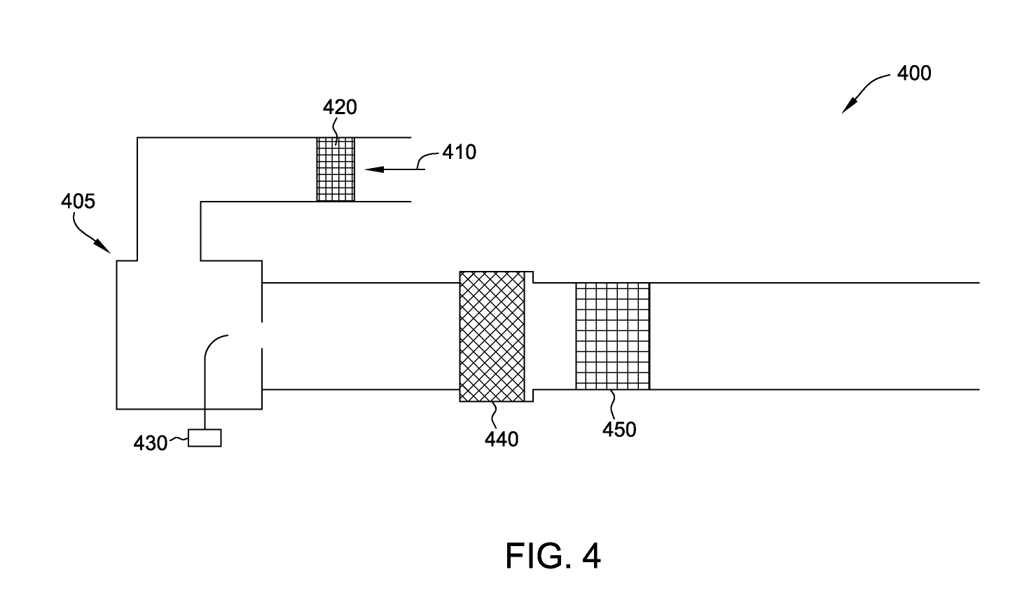

With reference to FIG. 4, a schematic illustration is shown of an exemplary filter test set-up 400 in a wind tunnel 405. Set-up 400 may be suitable for conducting fractional efficiency, loss of efficiency, and burst tests. An alternative embodiment of filter test set-up 400 may be performed in a test rig. The exemplary embodiment is one possible embodiment of set-up 400 and includes upstream HEPA filter 420 with a minimum classification of H13. Upstream HEPA filter 420 functions to prevent ambient air particles from entering wind tunnel 405 and loading test filter 440. Air 410 supplied to wind tunnel 405 can be taken from indoors, outdoors, or re-circulated. Air 410 may be supplied either upstream or downstream of the test filter 440. Air 410 may be constant throughout the duration of the test. Dust feeder 430 releases test dust towards test filter 440. Dust feeder 430 may use any suitable test dust type depending on the operating condition of the associated gas turbine. In one embodiment, the standard ASHRAE 52.2 test dust is used. In another embodiment, there may be one or more compressed air operated dusk injectors (not shown) to disperse the test dust uniformly across the air inlet face of test filter 440. In yet another embodiment, there may be one or more water spray nozzles (not shown) to disperse mists of water uniformly across the air inlet face of test filter 440. Test filter 440 can be any suitable filter type depending on the associated gas turbine. Final filter 450 is installed downstream of test filter 440 and may operate at design operating airflow. Final filter 450 collects test dusts that pass through test filter 440. In another embodiment, there may be a downstream HEPA filter (not shown) in wind tunnel 405. In alternative embodiments, the location and amount of each component (i.e., HEPA filter, dust feeder, etc.) in wind tunnel 405 may be different.

There is currently no industry standard available for testing the durability of gas turbine filter elements for use in either high or low ambient temperature operating environments. High or low ambient temperatures may cause materials of gas turbine filter elements to fail prematurely during operation. Such a failure may pose serious risks to the gas turbine itself. As described herein, methods are provided for evaluating the durability of gas turbine filter elements under high and low ambient temperature operating environments. Knowledge of a particular filter's durability may greatly reduce the likelihood of premature filter failure during operation and therefore greatly reduce the risks posed to the gas turbine.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods. For example, hot and cold ambient temperature tests may be combined to form a joint hot/cold robustness test.

Some embodiments involve the use of one or more electronic or computing devices. Such devices typically include a processor or controller, such as, for example, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device, and/or a memory device. Such instructions, when executed by a processor, cause the processor to perform at least a portion of the methods described herein. The above examples are exemplary only, and thus are not intended to limit in any way the definition and/or meaning of the term processor.

While the invention has been described in terms of various specific embodiments, those skilled in the art will recognize that the invention can be practiced with modification within the spirit and scope of the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of testing a gas turbine filter for use in a high ambient temperature operating environment, said method comprising:
performing a first fractional efficiency test on the filter;
heating the filter to a first temperature that is higher than the ambient temperature surrounding the filter; and
performing a second fractional efficiency test on the filter after the filter has been heated for a predetermined amount of time at the first temperature.

2. The method in accordance with claim 1, further comprising:
loading the filter with a dust material;
heating the loaded filter to a second temperature that is higher than the ambient temperature; and
cooling the loaded filter from the second temperature to the ambient temperature after the loaded filter has been heated for a predetermined amount of time at the second temperature.

3. The method in accordance with claim 2, further comprising running a wet loss of efficiency test on the loaded filter and determining that the loaded filter has passed the wet loss of efficiency test.

4. The method in accordance with claim 3, further comprising running a wet burst test on the loaded filter after determining that the loaded filter has passed the wet loss of efficiency test.

5. The method in accordance with claim 1, wherein heating the filter to the first temperature comprises heating the filter at a controlled ramp rate to the first temperature.

6. The method in accordance with claim 5, wherein heating the filter comprises heating the filter at a ramp rate of between about 0.1° C. and about 15° C. per minute.

7. The method in accordance with claim 1, wherein heating the filter further comprises maintaining the filter at the first temperature for a period of time between about one hour to about twenty-four hours.

8. The method in accordance with claim 7, wherein heating the filter further comprises cycling the first temperature at a controlled ramp rate to a third temperature that is lower than the ambient temperature.

9. The method in accordance with claim 8, wherein cycling the first temperature comprises cooling the filter at a ramp rate of between about 0.1° C. and about 15° C. per minute.

10. The method in accordance with claim 8, further comprising:
performing at least once:
heating the filter to the first temperature;
maintaining the filter at the first temperature for a period of time between about one hour to about twenty-four hours; and
cycling the first temperature to the third temperature at a ramp rate of between about 0.1° C. and about 15° C. per minute.

11. A method of testing a gas turbine filter for use in a low ambient temperature operating environment, said method comprising:
performing a first fractional efficiency test on the filter;
cooling the filter to a first temperature that is lower than the ambient temperature surrounding the filter; and
performing a second fractional efficiency test on the filter after the filter has been cooled for a predetermined amount of time at the first temperature.

12. The method in accordance with claim 11, further comprising:
loading the filter with a dust material;
cooling the loaded filter to a second temperature that is lower than the ambient temperature; and
warming the loaded filter from the second temperature to the ambient temperature after the loaded filter has been cooled for a predetermined amount of time at the second temperature.

13. The method in accordance with claim 12, further comprising running a wet loss of efficiency test on the loaded filter and determining that the loaded filter has passed the wet loss of efficiency test.

14. The method in accordance with claim 13, further comprising running a wet burst test on the loaded filter after determining that the loaded filter has passed the wet loss of efficiency test.

15. The method in accordance with claim 11, wherein cooling the filter to the first temperature comprises cooling the filter to the first temperature at a controlled ramp rate of between about 0.1° C. and about 15° C. per minute.

16. The method in accordance with claim 11, wherein cooling the filter further comprises maintaining the filter at the first temperature for a period of time between about one hour to about twenty-four hours.

17. The method in accordance with claim 16, wherein cooling the filter further comprises pulsing the filter a predetermined number of times.

18. The method in accordance with claim 16, wherein cooling the filter further comprises cycling the first temperature at a controlled ramp rate to a third temperature that is higher than the ambient temperature.

19. The method in accordance with claim 18, wherein cycling the first temperature comprises warming the filter at a ramp rate of between about 0.1° C. and about 15° C. per minute.

20. The method in accordance with claim 18, further comprising:
performing at least once:
cooling the filter to the first temperature;
maintaining the filter at the first temperature for a period of time between about one hour to about twenty-four hours; and
cycling the first temperature to the third temperature at a controlled ramp rate of between about 0.1° C. and about 15° C. per minute.
